(19) United States
(12) Patent Application Publication
(10) Pub. No.: US 2025/0142269 A1
(43) Pub. Date: May 1, 2025

(54) Ear tip with filtering element for a hearing device or for a hearing device part

(71) Applicant: SONOVA AG, Staefa (CH)

(72) Inventors: Fabio Schmidt, Stäfa (CH); Petra Gunde, Stäfa (CH); Manuel Weibel, Stäfa (CH); Julia Lonsky, Stäfa (CH); Jonas Meyer, Stäfa (CH)

(21) Appl. No.: 18/815,292

(22) Filed: Aug. 26, 2024

(30) Foreign Application Priority Data
Oct. 31, 2023 (EP) 23206931.0

(51) Int. Cl. H04R 25/00

(52) U.S. Cl. CPC H04R 25/654; H04R 25/658; H04R 2460/11

(57) ABSTRACT

An ear tip is described for retaining a hearing device or a hearing device part in an ear canal of a user wearing the hearing device or the hearing device part. The ear tip includes a sealing element with a sound channel providing for a sound path between a sound inlet opening for receiving an acoustic signal from an output unit of the hearing device or the hearing device part and a sound outlet opening for releasing the acoustic signal to the ear canal of the user wearing the hearing device or the hearing device part, and a first filtering element arranged in the sound channel between the sound inlet opening and the sound outlet opening.

### RELATED APPLICATIONS

The present application claims priority to EP patent application Ser. No. 23/206,931.0, filed Oct. 31, 2023, which is hereby incorporated by reference in its entirety.

### BACKGROUND INFORMATION

Hearing devices in the present context include devices used for providing an output signal based on an electric audio signal to a user to evoke a hearing perception. The audio signal is representative of audio content and may be based on ambient sound captured by the hearing device itself or may be provided to the hearing device by an external audio source e.g., via an audio stream from an external microphone or a streaming service. The audio signal may be processed in the hearing device to obtain the output signal. The audio processing may include simple amplification but may also use other augmentation as e.g., situational enhancement of an acoustic scene as e.g., beamforming and/or active noise cancelling (ANC). Such hearing devices may be used to improve the hearing capability of a user and/or may be used for consuming audio content.

Hearing devices that are specifically configured to compensate for a hearing loss of hearing-impaired users are commonly referred to as hearing instruments, hearing aids or hearing prostheses. Hearing instruments are typically configured to produce an output signal that can be perceived by a user despite her or his hearing impairment. The output signal is typically based on ambient sound which may be captured in the vicinity of the user by an internal or external microphone. The output signal may comprise amplified and/or otherwise processed sound that can be delivered via a loudspeaker (also called “receiver” in the context of hearing instruments) to the auditory canal of a user. Bimodal hearing instruments may be configured to simultaneously provide a further mode for evoking a hearing sensation in addition to the output sound. The further mode may e.g., be based on bone vibrations for stimulating the cochlea via the bones of the skull or on electrical stimulation directly or indirectly applied to the auditory nerve of the user.

Hearing devices in the present context also include consumer devices which are primarily used for consuming audio content without particular emphasis on the compensation of a hearing loss. Such consumer devices include earbuds, earphones or headphones, hearables, or wearables as intelligent glasses etc. which are suitable to provide streamed audio content to the user. Consumer devices may be configured to simply convert an electrical audio signal into sound or, similarly to hearing instruments, they may use amplification or other audio processing as e.g., active noise cancelling to facilitate hearing or account for a hearing loss of a user. Similarly, hearing instruments may also include functionality of consumer devices and e.g., may be configured to provide streamed audio content to the user.

Hearing devices in the present context may also be implemented as hearing protection devices, such as earplugs, configured to protect the user's hearing. A hearing system comprising two hearing devices configured to be worn at different ears of the user is sometimes also referred to as a binaural hearing device.

Hearing devices, in particular hearing instruments may have different form factors such as behind-the-ear (BTE) hearing devices/aids, in-the-ear (ITE) hearing devices/aids, receiver-in-the-canal (RIC) hearing devices/aids, invisible-in-the-canal (IIC) hearing devices/aids, or completely-in-canal (CIC) hearing devices/aids etc. Such devices as a whole or at least parts of them need to be inserted into the ear canal of a user in order to deliver the output sound signal to the ear canal or to occlude the ear canal e.g., to protect the ear. The hearing device part inserted into the ear canal needs to be retained in place with sufficient reliability and comfort for the user while simultaneously fulfilling a sealing function for achieving the desired type of acoustic coupling of the hearing device to the ear canal (e.g., occluded or open fitting). To this end, hearing devices or the hearing device parts that need to be inserted into the ear canal typically comprise an ear tip made from a soft material. Such ear tips are also referred to as domes, caps, flexible insert mounts, or acoustic couplers. The ear tips typically comprise a sealing element made from a soft material as e.g., silicone that may adapt its shape to the shape of the ear canal in order to provide for an acoustic seal. The sealing element of such ear tips may have an e.g., umbrella-like or dome-like shape, a balloon-like shape, or a cone-like shape that is easy to insert into the ear canal. Ear tips typically comprise passages or openings passing through the ear tip, in particular through the sealing element, for delivering the aforementioned output sound signal to the user's ear canal.

During use, hearing devices or hearing device parts come in close contact with the user's ear and are exposed to pollutants as e.g., earwax, sebum, tissue particles or other debris. Tissue particles may include skin flakes or scales, as e.g., dandruff etc. Sebum is a slightly acidic oily substance produced by the sebaceous glands in the skin which helps moisturize and protect the skin. Earwax, also known as cerumen, is produced as a natural lubricant by the ear canal. Such pollutants, solid or liquid, are known to enter through any opening of hearing devices coming into contact with the ear canal or the ear in general. An opening particularly exposed to the ingress of such pollutants is a sound outlet of the ear tip. The pollutants may advance from there to electrical parts of the hearing device and/or may clog the opening. For example, when inserting the ear tip of the hearing device into the user's ear canal, pollutants may enter a sound channel which connects a functional component of the hearing device as e.g., a receiver with a sound outlet opening.

In order to prevent or inhibit ingress of pollutants as earwax or other debris into functional components of the hearing device, it is known to incorporate filtering elements in the relevant parts of hearing devices. Such filtering elements are also often simply referred to as wax filters while providing a barrier against ingress of all sorts of pollution. The wax filters are typically arranged in or downstream of outer openings that may allow ingress of pollutants. Such wax filters, however, often influence the acoustic properties of the hearing device as they are typically arranged in acoustically relevant cavities or channels of the hearing device. The wax filters may also quickly deteriorate due to accumulation of earwax or other pollutants which leads to a reduced volume of transmitted sound or a muffled tone.

Existing solutions address this issue with a system that requires the user to exchange the protection system, i.e., the wax filter. Replacement of the wax filters, however, may be difficult for the hearing device user due to problems while handling such miniature components. These problems can lead to improper placement of the wax filter and, thus, may result in inadequate protection of the hearing device components as e.g., the receiver. Furthermore, wax filters typically require an additional tool for the replacement process. The application of such a removal tool may result in pollutants, which should be removed from the opening during removal of the wax filter, actually being pushed deeper into the opening. This can lead to clogging of the sensitive hearing device components, in particular a receiver and/or an acoustic passage etc. Apart from the difficulties in handling such miniature components, the user is required to have replacement wax filters available at all times in order to maintain the hearing device in good working condition with no alternatives in case replacement parts are not available.

Therefore, there is a need for providing a solution that allows for efficient prevention of contamination of hearing devices or hearing device parts with pollutants as e.g., earwax/cerumen, sebum, tissue particles, or other debris, that has good acoustic properties and that will enhance the ease of use of the hearing device.

### BRIEF DESCRIPTION OF THE DRAWINGS

The invention is further illustrated by way of exemplary specific implementations which are described in detail below and which are shown in the accompanying figures. The figures show schematically:

FIG. 1 a hearing device in the form of a hearing aid comprising a BTE-component and an ITE-component connected thereto, the ITE-component having an ear tip;

FIG. 2 a hearing device in the form of a hearable/ITE hearing device comprising an ear tip;

FIG. 3 a hearing device in the form of an earbud comprising an ear tip;

FIG. 4a a cross-section in a first longitudinal sectional plane of an ear tip comprising a sealing element;

FIG. 4b a cross-section in a second longitudinal sectional plane of the ear tip of FIG. 4a;

FIG. 4c the ear tip of FIG. 4a in a plan view onto the inside of the sealing element;

FIG. 4d the ear tip of FIG. 4a in a plan view onto the outside of the sealing element;

FIG. 5 the cross-section of FIG. 4a, wherein the ear tip is attached to a receiver (shown in an external view);

FIG. 6 a further ear tip depicted in a plan view onto an inside of a sealing element;

FIG. 7 another ear tip depicted in a plan view onto an inside of a sealing element;

FIG. 8a a contour of a filtering element of an ear tip corresponding to the ear tip of FIGS. 4a to 4d;

FIG. 8b a contour of a filtering element of an ear tip corresponding to the ear tip of FIG. 6;

FIG. 8c a contour of a filtering element of an ear tip corresponding to the ear tip of FIG. 7;

FIG. 8d a further contour of a filtering element of an ear tip;

FIG. 8e a further contour of a filtering element of an ear tip.

The figures are not drawn to scale and have various viewpoints and perspectives. Some components or operations shown in the figures may be separated into different blocks or combined into a single block for the purposes of discussion. Corresponding parts or components are generally referred to by the same reference numerals. The invention shall not be limited to the particular implementations and is intended to cover modifications, equivalents, and alternatives falling within the scope of the disclosed technology as defined by the appended claims.

### DETAILED DESCRIPTION

Described herein is an ear tip for retaining a hearing device or a hearing device part in an ear canal of a user wearing the hearing device or the hearing device part. The features described herein further concern an earpiece for a hearing device and a hearing device, in particular a hearing aid.

The ear tip comprises a sealing element with a sound channel. The sound channel provides for a sound path between a sound inlet opening for receiving an acoustic signal from an output unit of the hearing device or the hearing device part and a sound outlet opening for releasing the acoustic signal to the ear canal of the user wearing the hearing device or the hearing device part. The output unit typically comprises an electro-acoustic transducer in the form of a receiver or loudspeaker having a sound outlet opening that may be directly connected to the sound inlet opening of the ear tip. The ear tip comprises a first filtering element arranged in said sound channel between the sound inlet opening and the sound outlet opening. The term “first” herein does not imply the presence of a second filtering element and is only used to distinguish the present filtering element from an optional further, second filtering element. The first filtering element comprises a plurality of protrusions which are arranged along a perimeter of a cross-section of said sound channel and which project inwardly, into the sound channel. In some examples, the protrusions extend only partially into the sound channel such that the plurality of protrusions partially obstructs said cross-section and leaves a partial area of said cross-section unobstructed.

The sound channel of the inventive ear tip provides for an acoustic passage penetrating through the sealing element and connects the sound inlet opening on one side of the sealing element with the sound outlet opening on an opposite side of the sealing element. The sound inlet opening is usually provided on an inside of the sealing element, i.e., a side of the sealing element that is generally facing the outside of the ear canal, whereas the sound outlet opening is typically provided on an outside of the sealing element, i.e., the side of the sealing element that faces into the ear canal when worn by a user. The sound channel thereby defines a sound path, i.e., a path defined by the direction in which the sound passes through the sound channel at a given location. The sound channel may have a variable cross-section along its length and may extend linearly or curved resulting in a linear or curved sound path, respectively. A linearly extending sound channel may be advantageous due to its simplicity, in particular in terms of manufacturability. In an embodiment, the sound channel has an essentially cylindrical shape, in particular a circular cylindrical shape.

The first filtering element, and with it the cross-section which is partially obstructed by said filtering element, is arranged at a position between the sound inlet opening and the sound outlet opening. In order to efficiently prevent ingress of earwax or other pollutants and to be easier to access for cleaning, the filtering element may be positioned closer to one of the sound openings, usually closer to the sound outlet opening which is exposed to the ear canal of a user when in use.

The unobstructed area of the cross-section is delimited by the plurality of protrusions together with the peripheral inner surface of the sound channel. The unobstructed area allows sound to propagate through the sound channel whereas the plurality of protrusions inhibit or hinder the progression of earwax or other pollutants through the sound channel, in particular in a region in proximity to the inner peripheral surface of the sound channel. The unobstructed area may be topologically connected in the plane of said cross-section, i.e., each two virtual points of the unobstructed area can be connected by a virtual continuous line within the plane of said cross-section. A topologically connected unobstructed area of said first filtering element exhibits advantageous acoustic properties on the one hand, whereas it enhances the ease of manufacture by reducing the complexity of the constructive elements or structures on the other hand.

In some examples, the protrusions of said first filtering element project partially into the sound channel, i.e., the protrusions only extend partially across said cross-section of the sound channel. The projections thus have a free end with which they project inwardly into the sound channel. “Project inwardly” herein refers to extending from an area at the perimeter or circumference of said sound channel into a void or cavity of the sound channel through which the sound propagates. The perimeter of the sound channel at said cross-section may be defined by an inner surface of a wall delimiting the sound channel but may also be defined by e.g., a circumferential inner ridge protruding from such a peripheral wall and narrowing the sound channel at the position of said cross-section in a throat-like manner.

The protrusions typically project inwardly in a “lateral” direction which hereby refers to a lateral direction with respect to a sound path defined by the sound channel. The sound path may be defined as the main direction of sound propagation along the sound channel and may be defined by the set of centroids of all cross-sections along the sound channel from sound inlet opening to sound outlet opening. In the case of an essentially cylindrical sound channel, for instance, with a tubular cavity or void for sound propagation, the main direction of sound propagation may be defined by a longitudinal cylinder axis and a “lateral” direction refers to a radial direction with respect to the longitudinal axis. Dependent on the specific embodiment, the free ends of the protrusions also may be referred to as “free lateral ends” or, as the case may be, as “free radial ends”. The cylindrical sound channel may have a circular cross-section (circular cylinder) but may also have e.g., oval or polygonal cross-sections or may have any other shape. The sound channel may also have non-cylindrical shape and can have e.g., a cavity or void that is delimited by a cambered or bulged peripheral inner surface.

The first filtering element of the ear tip described herein takes into account several insights gained in extensive experiments conducted by the inventors. On the one hand, it has been found that progression of earwax or other pollutants, in particular viscous pollutants, through an e.g., tubular cavity with dimensions typical for hearing devices may be inhibited comparatively efficiently by providing barriers or obstacles only at the inner peripheral surface delimiting the cavity. As such, sufficient inhibition of the progression of earwax or other pollutants may be achieved without the need of barriers or obstacles spanning across the whole cross-section of the tubular cavity as it is known for instance from conventional wax filters which use grids, bridging bars, spokes, or perforated plates etc. The partially inwardly projecting protrusions of the filtering element take this insight into account in that they may obstruct an area in proximity of the perimeter of said cross-section (from where the protrusions project) but not an area further away from the perimeter, closer to a central area of the cross-section. Such a filtering element has been found to be easy to clean as the unobstructed area may be comparatively large and easier to access than in conventional wax filters. In addition, the unobstructed area can be formed as a closed and topologically connected area further facilitating the cleaning and maintenance of the filtering element. Apart from these advantages, the particular construction of the first filtering element may allow manufacturing of the ear tip in a single molding process, in particular in an injection molding process, and thus allows the ear tip to be manufactured as a monolithic body made from a single material.

As a result, the first filtering element of the ear tip does not need to be separately replaced and can be formed as an integral part of the ear tip or its sealing element. Having the filtering element as an integral part of the ear tip or its sealing element has several advantages as the filtering element cannot be lost, e.g., lost in the ear canal while being worn or lost during handling for maintenance, and does not need to be replaced. In order to clean the filtering element from accumulated earwax or other pollutant, the user may detach the whole ear tip or the sealing element from the hearing device or hearing device part and simply rinse it in e.g., lukewarm and/or soapy water. The handling of the comparatively large ear tip as a whole is much easier than the handling of the miniature replaceable wax filters of the prior art and can easily be achieved even by users with impaired motor skills. At the same time, the user does not need to have consumables such as replacement wax filters available at all times. Should the ear tip and/or the filtering element deteriorate after prolonged use, the whole ear tip can be easily and cheaply replaced. This, however, will only become necessary on timescales far longer than replacement intervals for conventional wax filters that need to be replaced every time they are clogged.

On the other hand, it has surprisingly been found that the filtering element of the ear tip exhibits advantageous acoustic properties. One contributing factor is assumed to be the reduction of the overall obstructed area of the cross-section of the sound channel as compared to conventional wax filters. Furthermore, the shape of the unobstructed area in some examples may advantageously support the propagation of sound through the sound channel and, as such, further enhance the acoustic properties. Another contributing factor may be that the protrusions have free ends which result in a different resonant behavior as compared to conventional wax filters having barriers as e.g., grids or bars that fully bridge the sound channel and that are thus intrinsically more rigid and/or have less favorable oscillation modes (assuming the use of the same material for comparison).

The ear tip described herein has also proven to be advantageous in terms of manufacturability in that the plurality of protrusions are comparatively simple to manufacture e.g., in a molding or printing process due to the only partial projection into the sound channel and the thus resulting lack of thin and elongate elements bridging the cross-section of the sound channel. In particular in the case of an essentially cylindrical sound channel, the ear tip including the filtering element described herein can be easily manufactured in a conventional injection or compression molding process using e.g., retractable cores in the molding tools assisting in the forming of the plurality of protrusions.

The ear tip or the sealing element may comprise attachment means for attaching it to the hearing device or the hearing device part. Typical attachment means are circumferential grooves arranged at the sound inlet opening that may engage in a latching manner with corresponding circumferential flanges or protrusions of the hearing device or hearing device part. The ear tip or the sealing element may be configured to be directly attached to an output unit of the hearing device or hearing device part as e.g., to a spout of a receiver of the hearing device or hearing device part. The ear tip or the sealing element may also be configured to be attached to a sound tube of a hearing device which leads sound from an output unit of the hearing device to the ear of a user. The attachment or coupling means of the ear tip or sealing element may be configured to fit a standardized corresponding coupling section of the hearing device or hearing device part.

Further described herein is a filtering element as such, which is configured to be arranged between a sound inlet opening and a sound outlet opening of a sound channel of a hearing device or a hearing device part. The filtering element comprises a peripheral wall defining a sound channel through the filtering element. To this end, the filtering element may comprise a main body in which the peripheral wall is arranged to form the sound channel. The filtering element described herein comprises a plurality of protrusions which are arranged along a perimeter of a cross-section defined by said peripheral wall and which project inwardly into the sound channel. In some examples, the protrusions extend only partially into the sound channel. The plurality of protrusions partially obstructs said cross-section and leaves a partial area of said cross-section unobstructed. Such a filtering element may be provided as a separate part which may be inserted into a corresponding receptacle in a sound channel of a correspondingly configured ear tip. The filtering element may be provided as an exchangeable part or may be fixedly installed in such an ear tip. Further embodiments and features of such a filtering element may easily be gathered from the disclosure of the ear tip described herein.

In an embodiment of the ear tip, the plurality of protrusions is formed and arranged to obstruct less than 75%, e.g., less than 50% of said cross-section of the sound channel. As a result, the first filtering element leaves more than 25%, e.g., more than 50% of the said cross-section unobstructed. Dependent on the shape of the sound channel, the size of the sound inlet and/or outlet opening and other constructive design features of the ear tip, it may be advantageous to obstruct different fractions of the overall area of the cross-section. The values of obstructing less than 75%, in particular less than 50% have proven to yield good results in terms of earwax or, more generally, pollutant retention as well as acoustic properties.

In an embodiment of the ear tip described herein, each protrusion of the plurality of protrusions may have a planar shaped body and is arranged with its planar shaped body in the plane of said cross-section. A planar shaped body hereby refers to a body that has dimensions that naturally indicate a main associated plane. Typically, the planar body has larger dimensions in two dimensions whereas a third dimension has a comparatively small dimension, the two larger dimensions thereby define the main plane. In some embodiments, the planar body has two outer surfaces on opposite sides of the body which are essentially parallel and are at a distance that is smaller than any of the dimensions of the outer surfaces. In this embodiment, the outer surfaces of the planar shaped body of the projection are typically arranged essentially parallel to the said cross-section whereas the (virtual) plane of the cross-section goes through the planar shaped body of the projection.

In an embodiment of the ear tip described herein, at least one of the protrusions may have a shape essentially of a circular ring segment in said cross-section, i.e., the protrusion has an outline/contour similar to a circular ring segment in a projection onto the plane of said cross-section. The circle segment forming the outer edge of the circular ring segment (i.e., the edge having a larger radius) may thereby correspond to the curvature of an inner peripheral surface of the sound channel. The circle segment forming an inner edge of the circular ring segment (i.e., the edge having the smaller radius) may form the said free end projecting inwardly into the sound channel. In embodiments where all protrusions have the shape of a circular ring segment, the protrusions may be arranged in regular intervals along the perimeter so as to form a regularly interrupted circular ring. The protrusions may leave a central circular area with outwardly extending radial arms between the circular ring segments unobstructed.

In an embodiment of the ear tip described herein, at least one of the protrusions has a rounded triangular shape in said cross-section. In the present context, this refers to the protrusion having an outline/contour of a rounded triangular shape in a projection on the plane of said cross-section. “Rounded triangular shape” hereby refers to a rounded edge at the free end of the protrusion which projects into the sound channel. The triangular contour at its base typically follows the peripheral inner surface of the sound channel along the perimeter of said cross-section. The sides of the triangular contour may be convexly or concavely curved, in particular they may form or comprise a circular arc. Such shapes may be advantageous regarding the design of the molding tools, in particular retractable cores thereof.

In an embodiment of the ear tip described herein, a maximal inward extension of each protrusion of the plurality of protrusions in the plane of said cross-section is less than ½, or less than ⅓, or less than ¼ of the diameter of said sound channel in a corresponding direction in the plane of said cross-section. In case of an essentially circular cylindrical sound channel, each protrusion of the plurality of protrusions has a maximum radial extension which is less than ½, or less than ⅓, or less than ¼ of the diameter of the cross-section of the sound channel.

In an embodiment of the ear tip described herein, all protrusions of the plurality of protrusions have the same shape in said cross-section, i.e., in the present understanding that the protrusion have the same outline/contour in a projection on the plane of said cross-section. As such, the first filtering element is composed of protrusions having identical shapes and, thus, may be easy to manufacture. In an embodiment, the protrusions of the plurality of protrusions may be evenly distributed along the perimeter of the sound channel at said cross-section. As such, the plurality of protrusions may form a regular pattern having a rotational symmetry in the plane of the cross-section, i.e., a symmetry regarding rotation about a virtual axis which is oriented perpendicular to the plane of the cross-section.

In an embodiment of the ear tip described herein, the plurality of protrusions comprises 2, 3, or 4 protrusions. The plurality of protrusions may be formed and arranged in such a manner that the unobstructed area has a 2-fold, 3-fold, or 4-fold rotational symmetry in the plane of the cross-section. The rotational symmetry hereby refers to a rotation about an axis conforming to the main direction of the sound path at said cross-section and, in case of an essentially cylindrical sound channel, the axis corresponds to the cylinder axis. In some embodiments, the partially unobstructed area of the first filtering element may have a trefoil-like or a quatrefoil-like shape, i.e., a contour typically comprising the outline of three or four partially overlapping circles or circular arcs. In the present understanding, however, trefoil-or quatrefoil-like shapes may also include shapes where the outlines of the circles do not necessarily overlap and form three or four separate arms with circular arc shaped contours. The arms are connected to a central, in particular circular, area of the unobstructed area. Such shapes may also be characterized to have three or four lobe-or pear-shaped arms extending from the central circular area.

In an embodiment of the ear tip described herein, the sound channel defines a linear sound path between said sound inlet opening and said first filtering element. The sound channel in this case may be configured such that a projection of the unobstructed area along said linear sound path is unobstructed between said sound inlet opening and said first filtering element. This particular design has the advantage that during manufacturing, one or more retractable cores of an injection or compression molding tool may reach through the sound channel between the said sound inlet opening and said first filtering element to assist forming the plurality of protrusions. In an essentially cylindric sound channel, the sound channel may define a linear sound path by its longitudinal direction at least between the sound inlet opening and the first filtering element and in particular along its whole length from sound inlet to sound outlet opening.

In an embodiment of the ear tip described herein, the first filtering element may comprise a further plurality of protrusions which is arranged along a perimeter of a further cross-section of said sound channel, wherein the protrusions of the further plurality of protrusions project laterally from the perimeter of said second cross-section partially into the sound channel, and wherein in the further cross-section is at a different position between the sound inlet opening and the sound outlet opening. As such, the first filtering element may comprise two or more pluralities of protrusions which each are arranged in a different plane along the sound channel, i.e., along a sound path defined by the sound channel. The contours of the two or more pluralities of protrusions of the different cross-sections in this embodiment may be congruent and fully overlapping in projection along the sound path.

In an embodiment of the ear tip described herein, the plurality of protrusions is integrally formed with at least the sealing element. In particular, the whole ear tip may be integrally formed as a whole, i.e., as a single part. This has the advantage that the filtering element cannot be lost and is inseparably connected to the sealing element or the whole ear tip. In particular, during maintenance, for instance when rinsing the sealing element or the whole ear tip in order to remove accumulated earwax or other pollutants, the first filtering element cannot be washed out and get lost. Also, as the sealing element or the whole ear tip may be integrally formed as a single part, it also does not disintegrate due to aging or any other natural causes on any reasonable timescale. This greatly facilitates manufacture of the sealing element or the ear tip as compared to ear tips with exchangeable wax filters as they are known in the prior art.

In an embodiment of the ear tip described herein, the sealing element is formed from a single material. In particular, the whole ear tip is formed from a single material. In some examples, the ear tip is made of a single material and forms a single piece. Typically, the sealing element or the whole ear tip is formed from a soft silicone material as it is inert, easy to clean and has a long lifetime. This has the advantage that the ear tip is easy to manufacture in a single molding or printing step and there is no risk of later separation of different material sections or loss of inserted components as it is known in the prior art which are e.g., held in the ear tip by form or friction fit. It is possible to form the sealing element or the whole ear tip in a molding process as e.g., injection molding or compression molding, or it can be formed in an additive manufacturing process as e.g., 3D-printing. It is also possible in some embodiments to us multi material manufacturing methods to form otherwise monolithic bodies from different materials. The sealing element or the whole ear tip may thereby have different sections having different material properties as e.g., different hardness while being manufactured in a single multi-material process, i.e., a process where two or more different materials are processed into one part at one time. Examples are for instance Multi-Material Additive Manufacturing (MMAM) or Multi-Material Injection Molding (MMM). However, in terms of ease of manufacture and economical aspects of the ear tip, it is generally desirable to form the ear tip from one single material.

In an embodiment of the ear tip described herein, the ear tip comprises a further filtering element, the further filtering element protruding from the sealing element and bridging the sound outlet opening of said sound channel. The further filtering element is also referred to as the “second filtering element” herein in order to distinguish it from the aforementioned filtering element, i.e., the first filtering element. The second filtering element may be arranged on the outside of the sealing element and may extend across the sound outlet opening, i.e., the second filtering element may extend from one side of the sound outlet opening to an opposite side of the sound outlet opening, bridging the sound outlet opening so as to at least partly cover the sound outlet opening. The second filtering element may have the shape of a rounded arch in a longitudinal cross-section of the sealing element. The second filtering element may thus form two opposing lateral sound ports for the sound released by the sound outlet opening of the sealing element. In other words, the second filtering element may comprise an arch or a cap which is arranged in front of said sound outlet opening and which has two laterally oriented sound ports which are in fluid communication, i.e., air communication, with the sound outlet opening. The second filtering element arranged in front of the sound outlet opening forms a first barrier to inhibit ingress of earwax or other pollutants into the sound channel through the sound outlet opening. The second filtering element may thereby be particularly advantageous to prevent ingress of earwax or other pollutants during insertion of the ear tip into the ear canal, inhibiting the earwax or pollutants from being pressed through the sound outlet opening into the sound channel.

In an embodiment of the ear tip described herein, the ear tip may comprise a first collecting element arranged between said first filtering element and said sound outlet opening. The term “first collecting element” here does not imply the presence of a second collecting element and is only used to distinguish the said collecting element from an optional further, second collecting element. “Arranged between” hereby refers to a sequence along the sound path as defined by the sound channel and, depending on the shape of the sound channel, it may refer to a longitudinal position between said first filtering element and said sound outlet opening. The first collecting element typically comprises a collection cavity which is in fluid communication with the sound channel, e.g., via a corresponding collection opening in an inner peripheral surface of the sound channel, in order to remove earwax or other pollutants from the sound channel and accumulate it in the cavity.

In an embodiment of the ear tip described herein, the ear tip comprises a second collecting element arranged between said first filtering element and said sound inlet opening. The second collecting element also may comprise a collection cavity in fluid communication with the sound channel in order to remove earwax or other pollutants from the sound channel and accumulate it in the cavity, analogous to the first collecting element. An embodiment of the ear tip may have a first and a second collecting element. Other embodiments may have only a second collecting element but no first collecting element as described herein. The components may be arranged in the following sequence with respect to a sound path: sound inlet opening, second collecting element, first filtering element, first collecting element, sound outlet opening, and second filtering element. As such, the ear tip may comprise two filtering elements (i.e., the first and the second filtering element) and two collecting elements (i.e., the first and the second collecting element) in an alternating succession with respect to a direction of potential earwax or pollutant ingression. A combination of said first and second filtering element with said first and/or second collecting element results in a particularly reliable barrier against ingress into and propagation through the sound channel of earwax or other pollutants towards the sound inlet opening.

In an embodiment of the ear tip described herein, the first and/or the second collecting element are arranged directly adjacent to the first filtering element. In other words, the first collecting element is arranged upstream and adjacent to the first filtering element with respect to a direction of earwax or pollutant ingress whereas the second collecting element is arranged downstream and adjacent to the first filtering element.

In an embodiment of the ear tip described herein, the first and/or the second collecting element comprise(s) a cavity on an inner peripheral surface of said sound channel. The inner peripheral surface is typically formed on a peripheral wall delimiting the sound channel and the lateral direction refers to a lateral direction with respect to the main direction of a sound path defined by the sound channel.

In an embodiment of the ear tip described herein, both the first and the second collecting element comprise a cavity, wherein the cavity of the second collecting element has a larger volume than the cavity of the first collecting element. The second collecting element typically forms the last barrier for the earwax or pollutant progression towards the sound inlet opening. It may therefore be configured to collect all remaining earwax or pollutants that has not been accumulated by the previous barriers as e.g., the first collecting element or the first and/or second filtering element.

In an embodiment of the ear tips described herein, the cavity of the first and/or the second collecting element is/are formed as an annular recess fully encircling said sound channel. The recess may have a semi-circular cross-section in a longitudinal cross-section along the sound path. In other embodiments, the longitudinal cross-section of the recess may comprise a pocket-like extension forming an additional collection space for accumulating earwax or other pollutants. The cavities of the first and the second collecting element may be connected, each one separately or together, to an additional, e.g., larger, collection volume for earwax or other pollutants.

In an embodiment of the ear tip described herein, both the first and the second collecting element comprise an annular recess. In such an embodiment, the annular recess forming the second collecting element may have a larger maximal diameter than the annular recess forming the first collecting element.

As mentioned before, the ear tip described herein can be formed in an injection or compression molding process. However, the ear tip may also be formed by an additive manufacturing process as e.g., layered or volumetric 3D-printing.

Described herein is also an earpiece for a hearing device, in particular for a hearing aid, with an ear tip as described herein. The earpiece may comprise a sound output unit, in particular a receiver, which provides an acoustic signal to the sound inlet opening of the ear tip. The ear tip may be removably attachable to the sound output unit. The earpiece may also receive sound via a sound tube form a sound output unit in a BTE-component of the hearing device which is located behind the ear of a user when worn. The ear tip in this case may be removably attachable to the sound tube.

Described herein is also a hearing device, in particular a hearing aid, comprising an ear tip as described herein. The hearing device may comprise an earpiece as described above. The hearing device or the hearing aid may be an in-the-ear (ITE) hearing device or in-the-ear (ITE) hearing aid, respectively.

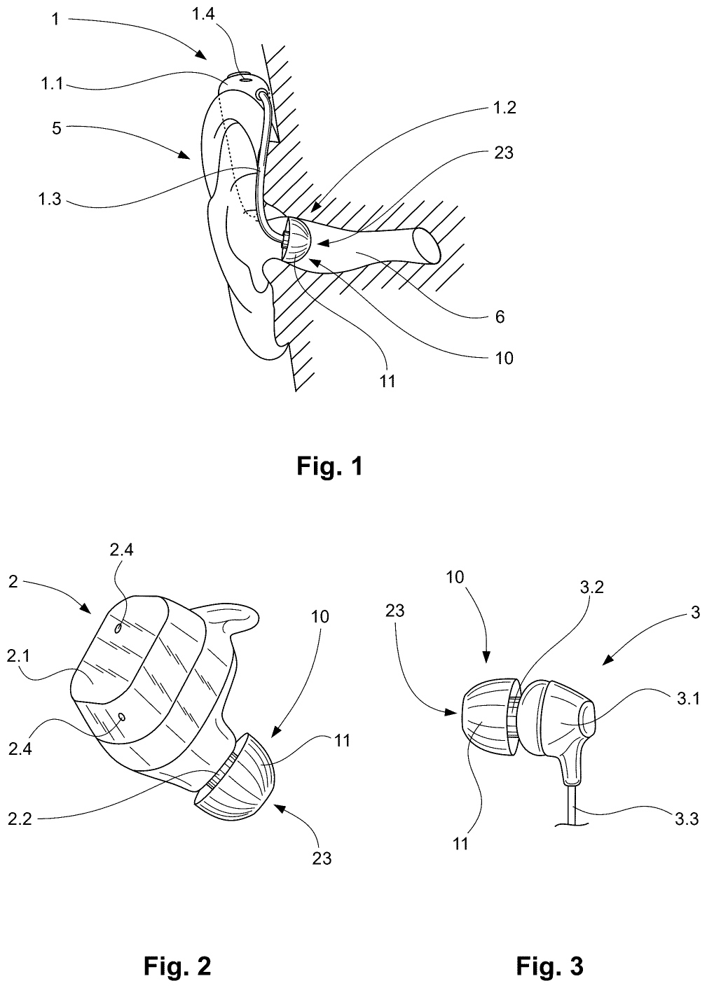

FIG. 1 shows a hearing device 1 in the form of a hearing aid comprising a behind-the-ear (BTE) component 1.1 located behind a pinna of an ear 5 of a user and an in-the-ear (ITE) component 1.2 located in an ear canal 6 of a user. The BTE-component 1.1 and the ITE-component 1.2 are connected via a connection 1.3.

The hearing device 1 comprises one or more electro-acoustic transducers 1.4 as e.g., microphones for receiving ambient sound and converting it into an electric audio signal representative of the ambient sound. The microphones may be arranged in the BTE-component 1.1 and/or the ITE-component 1.2. The electric audio signal may be used by an audio processing unit (not shown) of the hearing device 1 to produce a processed electrical output audio signal. The processing unit may be arranged in the BTE-component 1.1. An electro-acoustic transducer, i.e., a loudspeaker which may also be called “receiver”, is used for converting the output audio signal into output sound. The output sound is released via a sound outlet opening 23 of the ITE-component 1.2 directly into the ear canal 6 of the user.

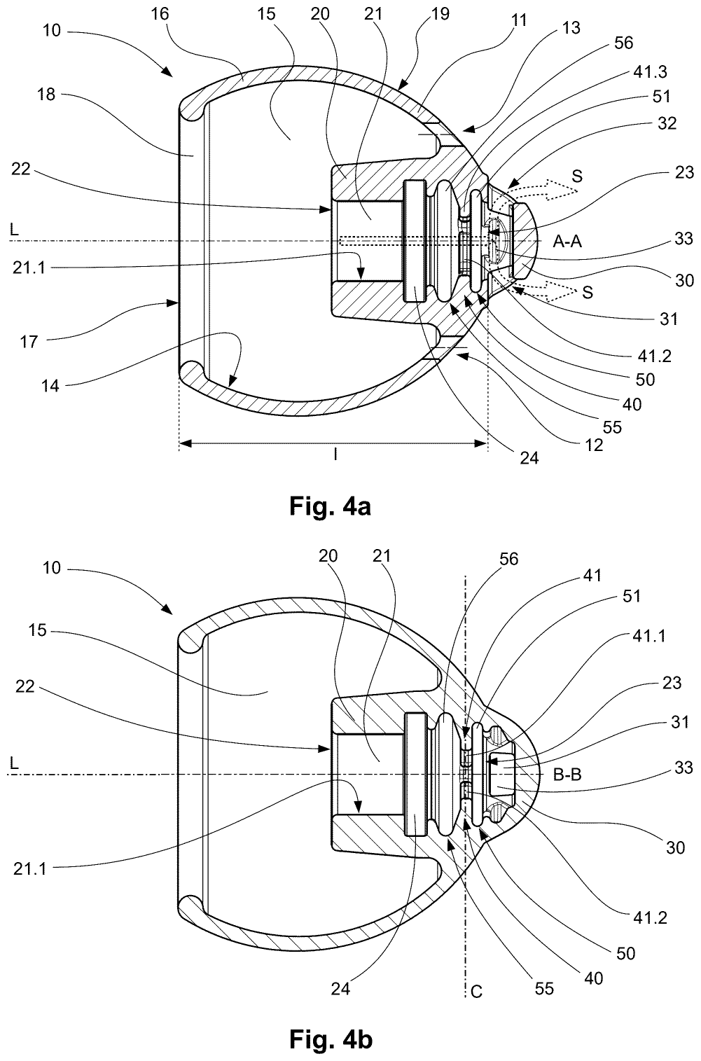

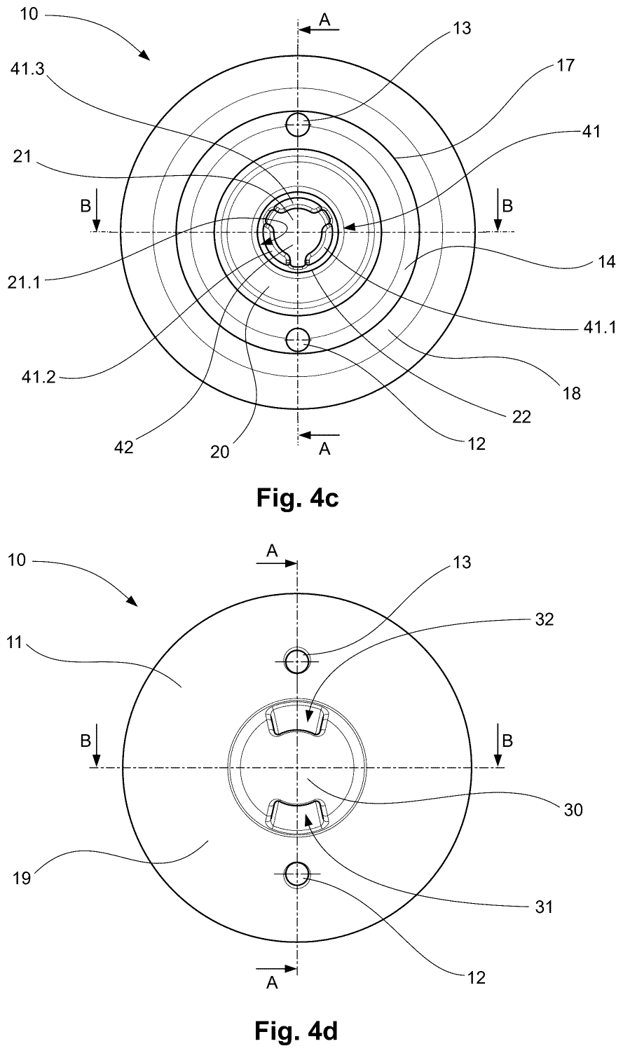

The ITE-component 1.2 forms an earpiece and comprises an ear tip 10. The ear tip 10 retains the ITE-component 1.2 in the ear canal 6. The ear tip 10 comprises a sealing element 11 which is typically made from a soft and resilient material as e.g., silicone. The sealing element 11 comprises a comparatively thin-walled dome-like or umbrella-like shaped structure 16 (see also FIGS. 4a and 4b). The dome-like shaped structure 16 of the sealing element 11 is made from a soft and resilient material and may adapt to the specific shape of the ear canal 6 and, due to its resilience, exert a pressure onto the inner wall of the ear canal 6. Due to the pressure and its resilience, the sealing element 11 may lie tight against an inner wall of the ear canal 6 and, thus, may acoustically seal the ear canal 6 with respect to ambient sound. The sealing element 11, in particular the dome-like shaped structure 16, may include vent openings for preventing occlusion effects and for allowing a controlled acoustic fluid communication, i.e., air communication, of the ear canal 6 with ambient air.

Due to its dome-like shaped structure 16, the sealing element 11 counteracts a pull-out force and retains the ITE-component 1.2 in the ear canal 6. An essentially rotationally symmetric shape with respect to a longitudinal axis of the ear tip 10 also allows for maintaining a centerline in the ear canal 6 which ensures proper positioning of e.g., a sound outlet opening 23 of the sealing element 11.

The receiver may be located in the ITE-component 1.2 and may be electrically connected to a signal processing unit of the BTE-component 1.1. In this case, the hearing aid is usually referred to as a receiver-in-canal (RIC) device and the connection 1.3 between the BTE-component 1.1 and the ITE-component 1.2 is provided by a cable comprising electrical wires. The ear tip 10 may be directly attached to the receiver or may be attached to a further part of the ITE-component 1.1 as e.g., a housing. In other embodiments, the ITE-component 1.2 may be passive and may only serve as a sound outlet for sound provided by a receiver located in the BTE-component 1.1. In this case, the connection 1.3 is typically provided by a sound tube which guides the sound emitted by the receiver to the ITE-component 1.2. The sound may then be released into the ear canal 6 via the sound outlet opening 23 which is located in the sealing element 11. The ear tip 10 may be directly attached to the sound tube or to an end piece of the sound tube functioning as an output unit via a coupling mechanism or section.

FIG. 2 shows another hearing device 2 in the form of a hearable or ITE hearing device comprising the ear tip 10 for retaining the hearing device 2 in the ear canal 6 of the user. The ear tip 10 is attached to a housing 2.1 of the hearing device 2 which, when worn, is located in a concha of the ear 5 of the user. The ear tip 10 is inserted into and retains the hearing device 2 in the ear canal 6. An electro-acoustic transducer, i.e., a receiver, for providing sound (not shown) may be located in the housing 2.1. The housing 2.1 may comprise a sound outlet in the form of a spout 2.2. The ear tip 10 may be directly attached to the spout 2.2 and, thus, to the housing 2.1.

The hearing device 2 may be a consumer device, e.g., an earbud or an earphone. In other embodiments, the hearing device 2 may be a medical device as e.g., a hearing aid, in particular an in-the-ear (ITE) hearing aid. The hearing device 2 may comprise one or more electro-acoustic transducers 2.4 as e.g., microphones for receiving ambient sound and converting it into an electric audio signal representative of the ambient sound. The electric audio signal may be used by an audio processing unit (not shown) of the hearing device 2. Dependent on the embodiment, the hearing device 2 may include functionality for compensating a hearing loss of the user. Consumer devices may also be adapted to compensate for a hearing loss to some extent and/or may be configured to improve or facilitate the hearing experience of a user by processing the audio signal. Such audio processing may e.g., include active noise cancelling (ANC) or beamforming by using several microphones as a phased microphone array. Dependent on the emphasis of the hearing device 2, it may be regarded as a hearable (e.g., more emphasis on the functionality as a consumer device and to a lesser extent on the compensation of a hearing loss) or hearing aid (e.g., main focus on the function as a medical device for compensation of a hearing loss and to a lesser extent on consumer functionality).

FIG. 3 depicts another hearing device 3 in the form of an earbud or earphone. The earbud comprises a housing 3.1 with a spout 3.2. The spout 3.2 has a sound output opening for sound provided by a receiver (not shown) which is arranged inside the housing 3.1. The ear tip 10 may be directly attached to the spout 3.2 or, in other embodiments, may be attached to other parts of the housing 3.1. The earbud shown in FIG. 3 is wire-based and receives an electric audio signal via a cable 3.3.

FIGS. 4a to 4d show several views of the ear tip 10. FIG. 4a shows a cross-section in a first longitudinal sectional plane A (see also FIG. 4c) of the ear tip 10 comprising the sealing element 11. FIG. 4b shows another cross-section in a second longitudinal sectional plane B of the ear tip 10 (see also FIG. 4c). FIG. 4c shows a plan view of the ear tip 10 along a longitudinal axis L onto an inside of the sealing element 11 and FIG. 4d depicts a plan view onto an outside of the sealing element 11 along the axis L. FIGS. 4a to 4d are described together in the following. Herein, the terms “proximal” and “distal” refer to a direction of the ear canal 6, towards the eardrum and away from it, respectively.

The overall shape of the ear tip 10 is rotationally symmetric with respect to its longitudinal axis L with minor exceptions that are addressed below. The sealing element 11 of the ear tip 10 comprises the dome-like or umbrella-like shaped structure 16 which encloses an inside volume 15. The structure 16 is formed from a thin wall of a soft and resilient material as e.g., silicone and extends in longitudinal direction over a distance I. The structure 16 is open at a distal opening 17 which, when the ear tip 10 is worn in an ear canal 6, is facing the outside. The opening 17 has a stiffening rib 18 that extends along a contour of the opening 17 and which protrudes into the inside volume 15. The structure 16 has two off-center through passages 12 and 13 which extend in longitudinal direction of L from an inside surface 14 of the sealing element 11 to an outside surface 19. The passages 12 and 13 act as vent openings and provide for fluid communication, i.e., air communication, between the inside volume 15 (and thus via opening 17 with the ambient air when worn in an ear) and an inside volume of the ear canal 6.

The structure 16 extends from an outer circumference of a proximal end of a central core 20 of the sealing element 11. The central core 20 has an essentially circular cylindrical shape which is arranged coaxially with the longitudinal axis L. The core 20 extends roughly half of the longitudinal length I of the structure 16 into the inside volume 15. The core 20 comprises a sound channel 21 extending in longitudinal direction L through the core 20. The longitudinal direction L thus defines a sound path provided for by the sound channel 21. At a distal end, i.e., a longitudinal end arranged inside the inside volume 15, the sound channel 21 has a sound inlet opening 22 facing in longitudinal direction L which is in fluid, i.e., air, communication with the inside volume 15. At a proximal end, the sound channel 21 has the sound outlet opening 23 which faces in longitudinal direction L. The sound inlet opening 22 and the sound outlet opening 23 both fully overlap with a lateral cross-section (herein, lateral refers to a direction transverse to the longitudinal direction L). In other words, the sound channel 21 is open across its full cross-section at both openings 22 and 23.

The ear tip 10 comprises a cap 30 which is arranged in longitudinal direction L in front of and at a distance from the sound outlet opening 23. The cap 30 spans the sound outlet opening 23 from one side of the sound outlet opening 23 to a diametrically opposite side of the sound outlet opening 23. The cap 30 is configured to fully overlap the cross-section of opening 23 in a projection along L and comprises two lateral sound ports 31 and 32 which are arranged diametrically with respect to the longitudinal axis L. The sound ports 31 and 32 are in fluid communication, i.e., air communication, with the sound channel 21 via the sound outlet opening 23 and an interior void 33 of the cap 30. The cap 30 forms a second filtering element (a first filtering element is described below) in that it inhibits earwax and other pollutants from directly entering the sound outlet opening 23. As the sound ports 31 and 32 are oriented in lateral direction, the sound path from the sound channel 21 to the ear canal 6 follows a labyrinthic way S (see dashed arrows in FIG. 4a) and thus inhibits ingress of earwax or other pollutants into the sound channel 21.

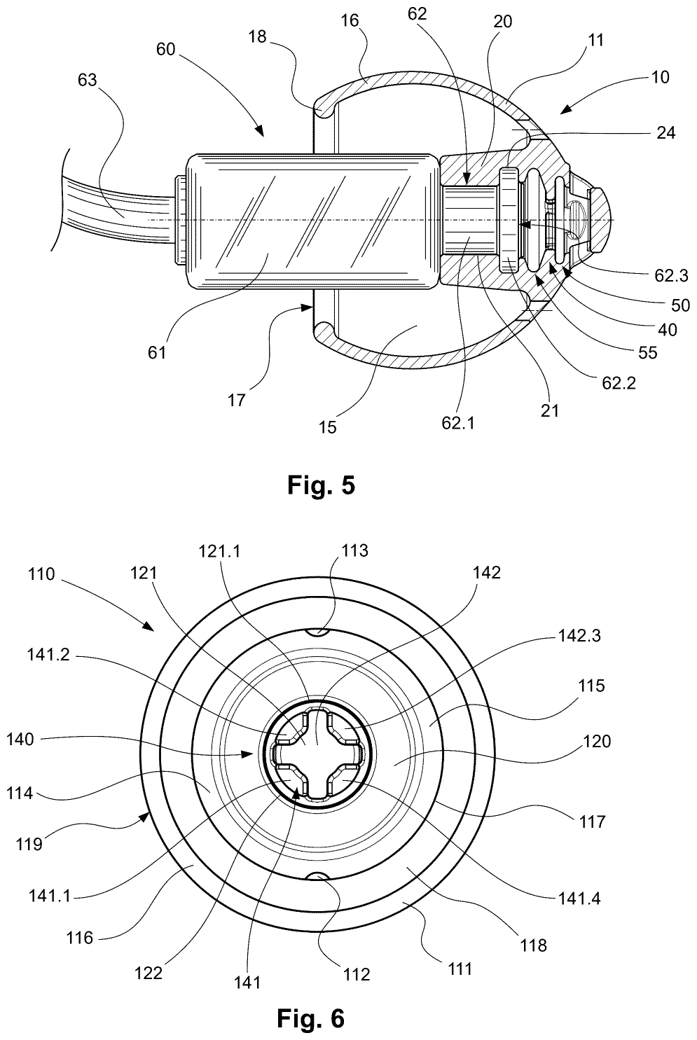

Roughly halfway along its longitudinal length, the sound channel 21 comprises a groove 24 along its peripheral inside surface. The groove 24 fully encircles the sound channel 21 and forms a latching groove 24 for a corresponding latching flange 62.2 of a connecting piece of an output unit or a housing of a hearing device or a hearing device part (see also FIG. 5). As the sealing element 11 is formed from a soft and flexible resilient material, the core 20 may be slid over a connecting piece of the hearing device of corresponding diameter. A flange of the connecting piece may be brought into latching engagement with the groove 24. As such, the ear tip 10 may be securely but detachably attached to an output unit or a housing of the hearing device or a hearing device part. It is evident that other attachment means or latching configuration may be incorporated to attach the ear tip 10 to an output unit.

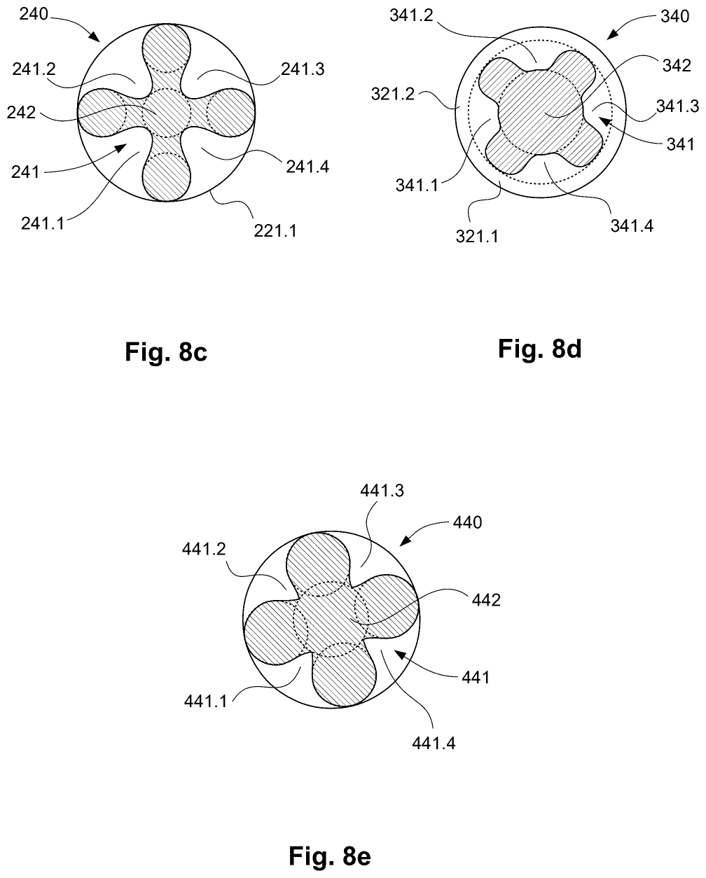

In some examples, the ear tip 10 has a first filtering element 40 that is provided at a location between the sound inlet opening 22 and the sound outlet opening 23 in longitudinal direction L. In the embodiments of FIGS. 4a to 4d, the first filtering element 40 is arranged in longitudinal direction along L about halfway between the groove 24 and the sound outlet opening 23. The first filtering element 40 comprises a plurality of protrusions 41 which extend from an inner peripheral wall 21.1 into the interior space of the sound channel 21. The plurality of protrusions 41 in the embodiment of FIGS. 4a to 4d comprises three protrusions 41.1 to 41.3. The protrusions 41.1 to 41.3 are arranged in a lateral plane C, i.e., a plane that is oriented perpendicularly to the longitudinal direction L. The protrusions 41.1 to 41.3 partially obstruct a cross-section of the sound channel 21 in said lateral plane C, leaving an unobstructed area 42 (see also FIGS. 8a to 8e). The protrusions 41.1 to 41.3 in the embodiment of FIGS. 4a to 4d each have a shape similar to a circular ring segment with rounded corners and are evenly distributed along the peripheral wall 21.1 in said plane C, i.e., along a perimeter of said cross-section. The protrusions 41.1 to 41.3 extend with free ends inwardly, i.e., into the sound channel 21, wherein the free ends are formed by the edges of the circular ring segments with the smaller curvature, i.e., the “inner” edges. The protrusions 41.1. to 41.3 are thereby at a distance from each other and are regularly distributed in peripheral direction. As such, the filtering element 40 can be regarded as a throat which narrows said sound channel 21 which is formed by a threefold interrupted ridge formed by the three protrusions 41.1 to 41.3 which project partially into the sound channel 21 from said peripheral wall 21.1. The first filtering element 40 thus has a 3-fold rotational symmetry with respect to the longitudinal direction L. The area 42 of the cross-section which is left unobstructed by the plurality of protrusions 40 thus yields a three-armed cross shape with a circular shaped central area. Several other exemplary embodiments of the first filtering element are described in further detail in FIGS. 6 to 7 and FIGS. 8a to 8e.

The ear tip 10 further comprises a first collecting element 50 arranged in longitudinal direction L between the first filtering element 40 and the sound outlet opening 23. The first collecting element 50 in the present embodiment comprises an annular groove or recess 51 in the peripheral wall 21.1 which delimits the sound channel 21. The annular groove 51 fully encircles the sound channel 21 in a peripheral direction and forms a bulging or widening of the sound channel 21 in a lateral direction. In the embodiment as shown, a longitudinal cross-section of the groove 51 has an essentially half-circular shape and the inner wall of the groove 51 smoothly transitions into the inner peripheral wall 21.1 of the sound channel 21. In the longitudinal direction L, the annular groove 51 is arranged directly adjacent to the first filtering element 40 and the surfaces of the protrusions 41.1 to 41.3 lie flush with the inner surface of the annular groove 51. The diameter of the annular groove 51 at its widest extension, i.e., the outermost circumference with respect to the longitudinal direction L, is larger than a diameter of the sound channel 21. In particular, the widest extension is wider than the diameter of the sound channel 21 by about twice the lateral depth of the groove 51.

A second collecting element 55 is arranged in longitudinal direction L between the first filtering element and the sound inlet opening 22, in particular between the latching groove 24 and the first filtering element 40. The second collecting element 55 in the present embodiment comprises an annular groove 56 or recess in the peripheral wall 21.1 which delimits the sound channel 21. The annular groove 56 fully encircles the sound channel 21 in a peripheral direction and forms a bulging or widening of the sound channel 21 in a lateral direction. In the embodiment as shown, a longitudinal cross-section of the groove 56 has a rounded conical shape. Similar to the first collecting element 50, the annular groove 56 is arranged directly adjacent to the first filtering element 40 and the surfaces of the protrusions 41.1 to 41.3 transition into an inner surface of the annular groove 56. The diameter of the annular groove 56 at its widest extension is larger than a diameter of the sound channel 21 as well as the diameter of the first collecting element 50. The groove 56 covers a larger volume than the groove 51 of the first collecting element 40, in particular a volume that is at least 2 times larger, e.g., about 4 times larger.

The first collecting element 50 is arranged upstream of the first filtering element 40 while the second collecting element 55 is arranged downstream with respect to a direction of earwax or pollutant ingress. The ear tip 10 therefore comprises four distinct elements for inhibiting ingress of earwax or other pollutants in the following sequence: the second filtering element 30, the first collecting element 50, the first filtering element 40 and the second collecting element 55. In other words, the ear tip 10 comprises two filtering elements 30 and 40, and two collecting elements 50 and 55 in alternating sequence along the direction of earwax ingression, starting with the filtering element 30 (or, the other way around, along a sound path from output unit to ear canal 60 starting with collecting element 55).

As depicted in FIGS. 4a to 4d, the ear tip 10 is formed in a monolithic way as one single piece, i.e., all parts as e.g., the sealing element 11 including the dome-like shaped structure 16 and the core 20, the filtering elements 30 and 40 as well as the collecting elements 50 and 55 are all formed as one single piece and may be formed from the same material. In some examples, the ear tip 10 is made in a single manufacturing step as a monolithic body from a single soft and resilient material. An illustrative material is silicone.

FIG. 5 shows the cross-section of the ear tip 10 according to FIG. 4a, wherein the ear tip 10 is attached to a receiver 60. The receiver 60 is shown in an external view. The receiver 60 comprises an elongate housing 61. At its distal longitudinal end, the housing 61 has a cable junction for a cable 63 connecting the receiver 60 to another part of a hearing device. At a proximal longitudinal end, the housing 61 comprises a spout 62 including an essentially circular cylindrical connection piece 62.1 with a laterally outwardly protruding flange 62.2 at its proximal end. The spout 62 extends in the longitudinal direction of the elongate housing 61 of the receiver 60 and comprises a sound passage (not visible) for releasing sound generated in the interior of housing 61. The sound passage of the spout 62 has a sound outlet opening 62.3 at a front face of the spout 62 facing in longitudinal direction of the receiver 60.

The spout 62 is inserted into the sound channel 21 of the core 20 through the sound inlet opening 22. The length of the connecting piece 62.1 is dimensioned such that, when the core 20 lies flat with its distal end against a front face of the proximal end of housing 61, the flange 62.2 engages with the latching groove 24. The connecting piece 62.1 has the same diameter as the sound channel 21 and, with its lateral outside surface, rests against the inner peripheral wall 21.1 of the sound channel 21. The longitudinal axis of the receiver 60 is thereby coaxially arranged with the longitudinal axis L of the ear tip 10 and the receiver 60 extends out of the interior volume 15 through the opening 17 of the sealing element 11. The sealing element 11, in particular its dome-like shaped structure 16, thus partially encompasses the receiver 60 when the ear tip 10 is attached to it.

As such, the ear tip 10 is coupled to the receiver 60 by the latching engagement of groove 24 and flange 62.2. Since the ear tip 10 is made from a soft and resilient material, the ear tip 10 may simply be slipped over the spout 62 in order to establish said latching engagement. Similarly, the ear tip 10 may be easily removed by elastic deformation, if needed, e.g., for rinsing or replacing it.

FIG. 6 shows a further ear tip 110 comprising a sealing element 111 depicted in a plan view onto a distal side of the sealing element 111. The ear tip 110 is similar to ear tip 10 and mainly differs in the configuration of a filtering element 140 arranged in a sound channel 121 passing through a core 120 of the sealing element 111.

The sealing element 111 comprises the core 120, which has an essentially circular cylindrical shape, and a thin-walled dome-like shaped structure 116 extending from the core 120. The structure 116 of the sealing element 111 encloses an interior volume 115 and has an inside surface 114 and an outside surface 119. The interior volume 115 is in fluid communication, i.e., in air communication, with the ambient air via an opening 117, which has a stiffening rib or bulge 118 along its rim. A sound channel 121 with a sound inlet opening 122 and a sound outlet opening (not visible) is located within the core 120 and extends through the sealing element 111 along a longitudinal direction L of the ear tip 110. The dome-like shaped structure 116 has two off-center through passages 112 and 113 as vent openings which extend in longitudinal direction of L from an inside surface 114 of the sealing element 111 to the outside surface 119.

The ear tip 110 comprises a filtering element 140 arranged in the sound channel 121 at a position between the sound inlet opening 122 and the sound outlet opening. The filtering element 140 extends in a lateral cross-section of the sound channel 121 and comprises a plurality of protrusions 141. In contrast to the ear tip 10, the plurality of protrusions 140 comprises four protrusions 141.1 to 141.4 which are evenly distributed along a perimeter of said cross-section. The protrusions 141.1 to 141.4 extend with their free ends from the inner peripheral wall 121.1 inwardly partially into the sound channel 121. In the present embodiment, the protrusions 141.1 to 141.4 extend to about half a radius of the cross-section of the circular cylindrical sound channel 121.

The protrusions 141.1 to 141.4 are approximately shaped as circular ring segments with rounded corners and are arranged along the perimeter of the cross-section to yield an interrupted circular ring-shaped ridge on the inner peripheral surface 121.1 of the sound channel 121. The free ends of the protrusions 141.1 to 141.4 are thereby formed by the edges of the circular ring segments with the smaller curvature, i.e., the “inner” edges. As such, the filtering element 140 of the ear tip 110 has a 4-fold rotational symmetry with respect to the longitudinal direction L. An area 142 of the cross-section which is left unobstructed by the plurality of protrusions 140 has a cross-shape with a circular shaped central area.

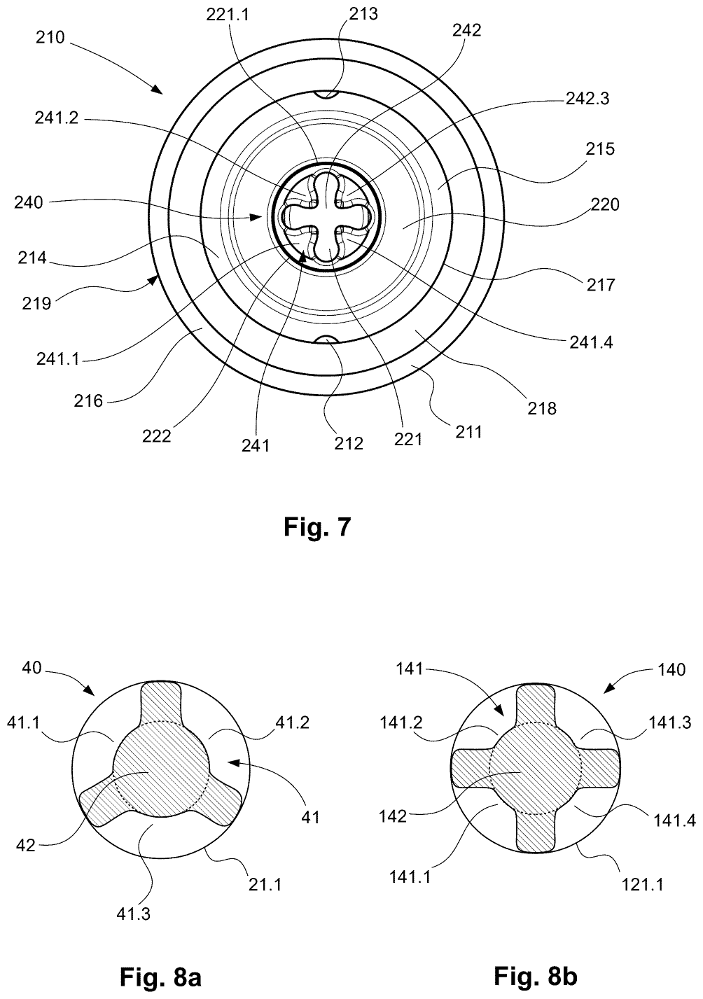

FIG. 7 shows a further ear tip 210 comprising a sealing element 211 depicted in a plan view onto a distal side of the sealing element 211. The ear tip 210 is similar to ear tip 10 and mainly differs in the configuration of a filtering element 240 arranged in a sound channel 221 passing through a core 220 of the sealing element 211.

The sealing element 211 comprises the core 220, which has an essentially circular cylindrical shape, and a thin-walled dome-like shaped structure 216 extending from the core 220. The structure 216 of the sealing element 211 encloses an interior volume 215 and has an inside surface 214 and an outside surface 219. The interior volume 215 is in fluid communication, i.e., air communication, with the ambient air via an opening 217, which has a stiffening rib 218 along its rim. A sound channel 221 with a sound inlet opening 222 and a sound outlet opening (not visible) is located within the core 220 and extends through the sealing element 211 along a longitudinal direction L of the ear tip 210. The structure 216 has two off-center through passages 212 and 213 as vent openings which extend in longitudinal direction of L from an inside surface 214 of the sealing element 211 to an outside surface 219.

The ear tip 210 comprises a filtering element 240 arranged in the sound channel 221 at a position between the sound inlet opening 222 and the sound outlet opening. The filtering element 240 is arranged in a lateral cross-section of the sound channel 221 and comprises a plurality of protrusions 241. The plurality of protrusions 240 comprises four protrusions 241.1 to 241.4 which are evenly distributed along a perimeter of said cross-section. The protrusions 241.1 to 241.4 extend with their free ends from the inner peripheral wall 221.1 partially inwardly into the sound channel 221. In the present embodiment, the protrusions 241.1 to 241.4 extend to about ⅔ of a radius of the cross-section of the sound channel 221.

The protrusions 241.1 to 241.4 are essentially shaped as triangles with concavely curved sides and rounded corners. The protrusions 241.1 to 241.4 are arranged along the perimeter of the cross-section delimited by the inner peripheral surface 221.1. The free ends of the protrusions 241.1 to 241.4 are formed by the protruding rounded corners of the triangles whereas the bases of the triangular protrusions 241.1 to 241.4 follow the inner peripheral surface 221.1. The concavely curved sides leave a partially circular area unobstructed between two neighboring triangles. As such, the plurality of protrusions 240 together leave an area 242 of the cross-section unobstructed which has a cross-shape with rounded, pear-shaped arms similar to a quatrefoil. The filtering element 240 of the ear tip 210 thus has a 4-fold rotational symmetry with respect to the longitudinal direction L.

FIGS. 8a to 8e show several different contour patterns indicating the obstructed/unobstructed area of filtering elements of ear tips.

FIG. 8a shows the contour of the plurality of protrusions 41 of the filtering element 40 of the ear tip 10 as shown in FIGS. 4a to 4d. The three protrusions 41.1 to 41.3 form an interrupted circular ring which laterally extends inwardly from the peripheral inner surface 21.1 of the sound channel 21. The interrupted circular ring extends up to about half a radius of the cross-section of the sound channel 21 indicated in FIG. 8a by a dashed circle. The hatched area in FIG. 8a shows the area 42 of the cross-section of the sound channel 21 that is left unobstructed by the plurality of protrusions 41. The shape of the unobstructed area 42 may be referred to as a three-armed cross-shape with a circular central area.

FIG. 8b shows the contour of the plurality of protrusions 141 of the filtering element 140 of the ear tip 110 as shown in FIG. 6. The four protrusions 141.1 to 141.4 form an interrupted circular ring which laterally extends inwardly from the peripheral inner surface 121.1 of the sound channel 121. The interrupted circular ring extends up to about half a radius of the cross-section of the sound channel 121 indicated in FIG. 8b by a dashed circle. The hatched area in FIG. 8b shows an unobstructed area 142 which may be referred to as cross-shape with a circular central area.

FIG. 8c shows the contour of the plurality of protrusions 241 of the filtering element 240 of the ear tip 210 as shown in FIG. 7. The protrusions 241.1 to 241.4 are roughly shaped as triangles with concavely curved sides and rounded corners which are arranged evenly distributed along the perimeter of the cross-section in which the filtering element 240 is arranged. The free ends of the protrusions 241.1 to 241.4 are formed by the protruding rounded corners of the respective triangle whereas the bases of the triangular protrusions 241.1 to 241.4 follow the inner peripheral surface 221.1 of the sound channel 221. The concavely curved sides of neighboring triangular protrusions as e.g., 241.1 and 241.2 connect at their bases and, due to the curved sides, form of the unobstructed area 242 which have a partially circular contour (indicated by dashed circles in FIG. 8c). A central area is also unobstructed as indicated by the central dashed circle. The protrusions 241.1 to 241.4 extend to about ⅔ of the radius of the circular cross-section from the peripheral surface 221.1 into the sound channel 221.

FIG. 8d shows a contour of another plurality of protrusions 341 of a filtering element 340 which is similar to the depiction in FIG. 8b. Protrusions 341.1 to 341.4 cover a smaller angular range than the protrusions 141.1 to 141.4. The arms of an unobstructed area 342, i.e., the gaps between the protrusions 341.1 to 341.4, are therefore wider than the ones of FIG. 8b. The arms of the unobstructed area 342 are also comparatively shorter since the protrusions 341.1 to 341.4 are connected with each other by a peripheral ledge 321.2 extending along a peripheral wall 321.1.

FIG. 8e shows a contour of another plurality of protrusions 441 of a filtering element 440 where an unobstructed area 442 forms a quatrefoil-like shape. In contrast to the contour shown in FIG. 8c, the (virtual) circles of the rounded arms of the unobstructed area 442 overlap with a central circular area as indicated by the dashed circles in FIG. 8e. The roughly triangular shaped protrusions 441.1 to 441.4 of the plurality of protrusions 441 have pointy edges at their free ends in this embodiment, in contrast to the rounded corners of the contours shown in FIG. 8c.

As described herein, a filtering element of an ear tip may be formed in various different shapes and may include 2, 3, 4, 5 or more protrusions, which may obstruct varying areas of a cross-section of a sound channel in the ear tip. The protrusions may connect to form a ledge along a perimeter of the cross-section or may directly connect to a peripheral inner surface of the sound channel. The contours of neighboring protrusions may be chosen to form new shapes together as e.g., part circles or other shapes. Typically, due to the filtering element comprising a plurality of protrusions which partially extend inwardly into the sound channel and partially obstruct the cross-section of the sound channel, the unobstructed area is composed of a circular central area with a plurality of arms of various shapes extending towards the peripheral inner surface which delimits the sound channel. The specific configuration of an ear tip as described herein allows for easy manufacture. The ear tip may particularly be formed as a monolithic body made from a single material.

What is claimed is:

1. An ear tip for retaining a hearing device or a hearing device part in an ear canal of a user wearing the hearing device or the hearing device part, the ear tip comprising:
a sealing element with a sound channel providing for a sound path between a sound inlet opening for receiving an acoustic signal from an output unit of the hearing device or the hearing device part and a sound outlet opening for releasing the acoustic signal to the ear canal of the user wearing the hearing device or the hearing device part,
a first filtering element arranged in the sound channel between the sound inlet opening and the sound outlet opening,
the first filtering element comprising a plurality of protrusions which are arranged along a perimeter of a cross-section of the sound channel and which project inwardly and extend partially into the sound channel,
wherein the plurality of protrusions partially obstructs the cross-section and leaves a partial area unobstructed,
wherein the ear tip is integrally formed of a resilient single material.

2. The ear tip according to claim 1, wherein the plurality of protrusions is formed and arranged to obstruct less than 75% of the cross-section of the sound channel.

3. The ear tip according to claim 1, wherein at least one of the protrusions has a shape of a circular ring segment in the cross-section.

4. The ear tip according to claim 1, wherein all protrusions have a same shape in the cross-section.

5. The ear tip according to claim 1, wherein a maximal inward extension of each protrusion in a plane of the cross-section is less than ½ of a diameter of the sound channel in the plane in a corresponding direction.

6. The ear tip according to claim 1, wherein the plurality of protrusions is formed and arranged in such a manner that the unobstructed area has a 2-fold, 3-fold, or 4-fold rotational symmetry in a plane of the cross-section.

7. The ear tip according to claim 1, comprising a second filtering element, the second filtering element protruding from the sealing element and bridging the sound outlet opening of the sound channel.

8. The ear tip according to claim 7, where the second filtering element comprises a cap which is arranged in front of the sound outlet opening and two laterally oriented sound ports which are in fluid communication with the sound outlet opening such that the sound path follows a labyrinthic way.

9. The ear tip according to claim 1, comprising a first collecting element arranged between the first filtering element and the sound outlet opening.

10. The ear tip according to claim 9, comprising a second collecting element arranged between the first filtering element and the sound inlet opening.

11. The ear tip according to claim 10, wherein the first and/or the second collecting element are arranged directly adjacent to the first filtering element.

12. The ear tip according to claim 10, wherein the first and/or the second collecting element comprises a cavity on an inner peripheral surface of the sound channel.

13. The ear tip according to claim 1 formed in an injection or compression molding process.

14. An earpiece for a hearing device, comprising an ear tip according to claim 1.

15. A hearing device comprising an ear tip according to claim 1.
